(19) United States
(12) Patent Application Publication
(10) Pub. No.: US 2015/0080053 A1
(43) Pub. Date: Mar. 19, 2015

(54) CELLULAR DEVICE CASE WITH AUXILIARY DEVICE POWER

(71) Applicant: Lotus Vaping Technologies, LLC., Boise, ID (US)

(72) Inventors: Mark A Ciccarello, Meridian, ID (US); Michael Larsen, Meridian, ID (US)

(21) Appl. No.: 14/339,044

(22) Filed: Jul. 23, 2014

Related U.S. Application Data
(60) Provisional application No. 61/857,502, filed on Jul. 23, 2013.

(51) Int. Cl. H04M 1/725; H04M 1/02

(52) U.S. Cl. CPC H04M 1/72575; H04M 1/026
USPC 455/557

(57) ABSTRACT

Disclosed embodiments include a cellular device case having at least one edge to allow the mounting of a cellular device therein, a recess to house a battery, a voltage regulator to vary the output of a battery, and a power connector to allow the connection of an electronic vapor device.

### CROSS-REFERENCE TO RELATED APPLICATIONS

This application claims priority under 35 U.S.C. § 119(e) to application Ser. No. 61/857,502, filed Jul. 23, 2013, titled “Cellular Device Case With Auxiliary Device Power,” which is hereby incorporated by reference.

### FIELD OF THE DISCLOSURE

The disclosure relates generally to accessories for cellular devices. In particular, the disclosure relates to a case for a cellular device with the capability of powering an accessory device, such as an electronic vapor device.

### BACKGROUND

Cellular devices have become commonplace and many people carry such a device virtually every day. Such devices often require a case or cover to protect the cellular device from damage.

In addition, many jurisdictions in the United States, and elsewhere, have increasingly regulated the places where smoking is forbidden. This had led to an increase in the use of electronic cigarettes (e-cig), personal vaporizers (PV), advanced personal vaporizers (AVP), or electronic nicotine delivery systems (ENDS), collectively referred to herein as electronic vapor devices.

In general, electronic vapor devices include an atomizer/heating element, a tank of liquid to be vaporized, and a power source. Various form factors are known from “cigarette-like” to “pipe-like” to “box-like” and variations in between.

It is often inconvenient to have to carry both a cellular device and an electronic vapor device. Existing systems do not solve the problems and inconveniences caused by the need to carry both devices.

### SUMMARY

The presently disclosed apparatus addresses the problems and inconveniences of existing systems. In addition, the presently disclosed apparatus has many advantages over existing systems.

For example, some disclosed embodiments include a cellular device case having at least one edge to allow the mounting of a cellular device therein, a recess to house a battery, a voltage regulator to vary the output of a battery, and a power connector to allow the connection of an electronic vapor device.

In some embodiments the power connector is threaded, and may preferably be threaded at 7 mm×0.5.

In some embodiments, the voltage regulator may comprise a variable voltage regulator. In some embodiments, the variable voltage regulator varies an output voltage in increments of 0.75 volts, and may vary an output voltage from 2.0 to 6.0 volts, or preferably, from 2.75 to 5.0 volts.

In some embodiments, the cellular device case includes a battery. In some embodiments, the battery is a rechargeable battery, and preferably, a lithium-ion battery.

In some embodiments, the cellular device case may include a battery charging port. In some embodiments, the battery charging port may be a mini-USB port.

In some embodiments, the cellular device case may include at least one vent in the power connector.

In some embodiments, the cellular device case may include power management circuitry capable of electrical communication with a battery. In some embodiments, the power management circuitry provides an indication of battery charge level. In still further embodiments, the cellular device case also includes at least one indicator that provides a visible indication of battery charge level, and preferably, the at least one indicator is an LED.

In some embodiments, the cellular device case may include power management circuitry capable of electrical communication with a battery. In some embodiments, the power management circuitry provides a reduction in a battery charging time and/or an automatic shut off of battery power. In still further embodiments, the automatic shut off of battery power occurs after a predetermined time.

### BRIEF DESCRIPTION OF THE DRAWINGS

FIG. 1 is a depiction of some disclosed embodiments showing the inside of a cellular device case as modified to provide attachment for an accessory such as an electronic vapor device.

FIG. 2 is a depiction of some disclosed embodiments showing a cellular device case with a cellular device inside, and as modified to provide attachment for an accessory such as an electronic vapor device.

FIG. 3 is a partial side view of some disclosed embodiments of the cellular device case.

FIG. 4 is a partial back and side view of some disclosed embodiments of the cellular device case.

FIG. 5 is a partial top view of some disclosed embodiments of the cellular device case.

FIG. 6 is a partial side view of some disclosed embodiments of the cellular device case.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

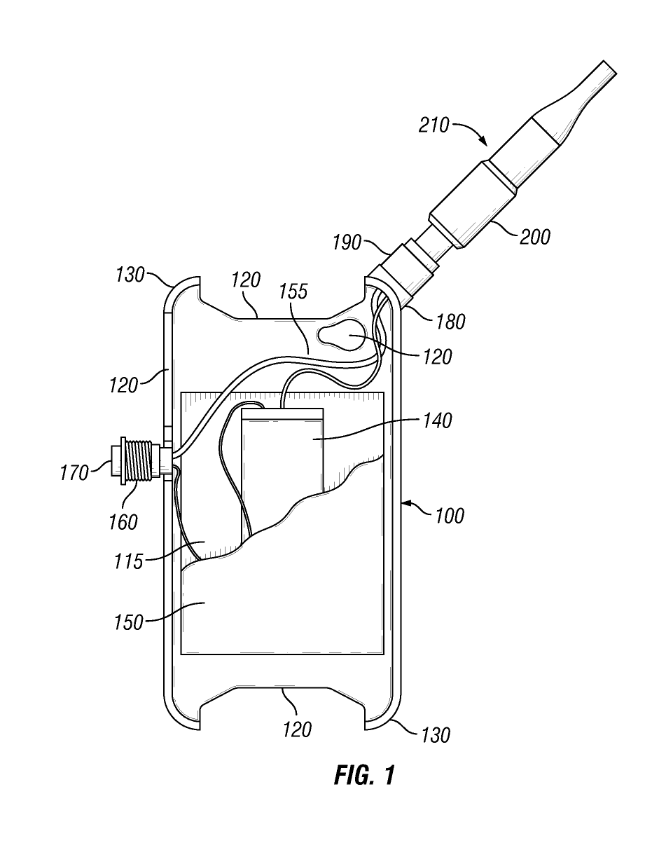

As shown in FIGS. 1-6 embodiments of a cellular device case 100 may be provided in a suitable form factor to provide a protective cover for at least a portion of a cellular device 110. As used herein “cellular device” encompasses any cellular telephone, smartphone, tablet, digital music player, or the like, whether the particular device is connectable to a cellular network or not.

As shown, various apertures, openings, or cutouts 120 and various lips, or edges 130 may be provided to secure the cellular device 110 within the cellular device case 100 while still allowing access to the various controls, ports, and buttons, on the cellular device 110. In addition, some cutouts 120 may allow various cameras, lights, or the like, to operate without interference from the cellular device case 100. Of course, the shapes, sizes, locations, and amount of cutouts 120 and edges 130 will vary according to, among other things, the particular locations of the features on the cellular device 110 intended to be used with the cellular device case 110.

Cellular device case 100 may comprise rubber, plastic, wood, metal, polymers, foam, or any other suitable cellular device case material, as well as combinations of the foregoing. In addition, device case 100 may be textured or have other features to facilitate gripping of the case by a human hand, and/or to facilitate the comfort of the user.

As shown in FIG. 1, some embodiments of the cellular device case 100 may include a recess 115 or other feature inside the case 100 to house a battery 140. Any battery suitable for use with an electronic vapor device 210 may be used. For some embodiments, the case 100 may contain an 1800-3000 mAh battery 140. For some embodiments a 2000 mAh battery 140 may be preferable. In some embodiments, the battery 140 may be a rechargeable battery, such as a lithium-ion battery or the like.

In some embodiments, a cover 150 may cover the battery 140. The cover may provide thermal, electrical, contact, and moisture protection in between the battery 140 and the cellular device 110. In some embodiments, cover 150 may comprise a fabric or paper-like substance that includes a moisture indicating feature, such as changing color when exposed to moisture, to provide additional safety or diagnostic advantages. Other safety or diagnostic features are also possible.

As indicated in FIG. 1, power connections 155 route power from the battery 140 to a voltage regulator 160, a switch 170, and then to a threaded power connector 180. In some embodiments, the voltage regulator 160 may comprise an adjustable voltage regulator. For example, voltage regulator may vary the voltage delivered from the battery 140 from 2.0-6.0 volts. The voltage regulator 160 may comprise a rotational, slidable, push button, or other selectable device to change the battery output voltage ether in discrete steps, or in a continuously variable manner. In some embodiments, it is preferable to configure voltage regulator 160 to have four slidable positions to allow the output voltage to be varied from 2.75V at a first position, to 3.5V at a second position, to 4.25V at a third position, to 5.0V at a fourth position. Other configurations are also possible.

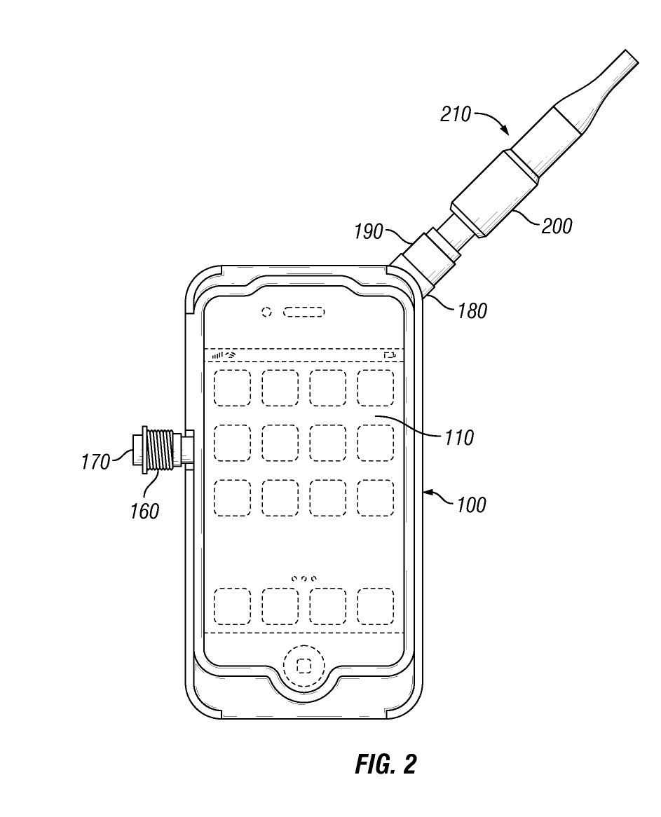

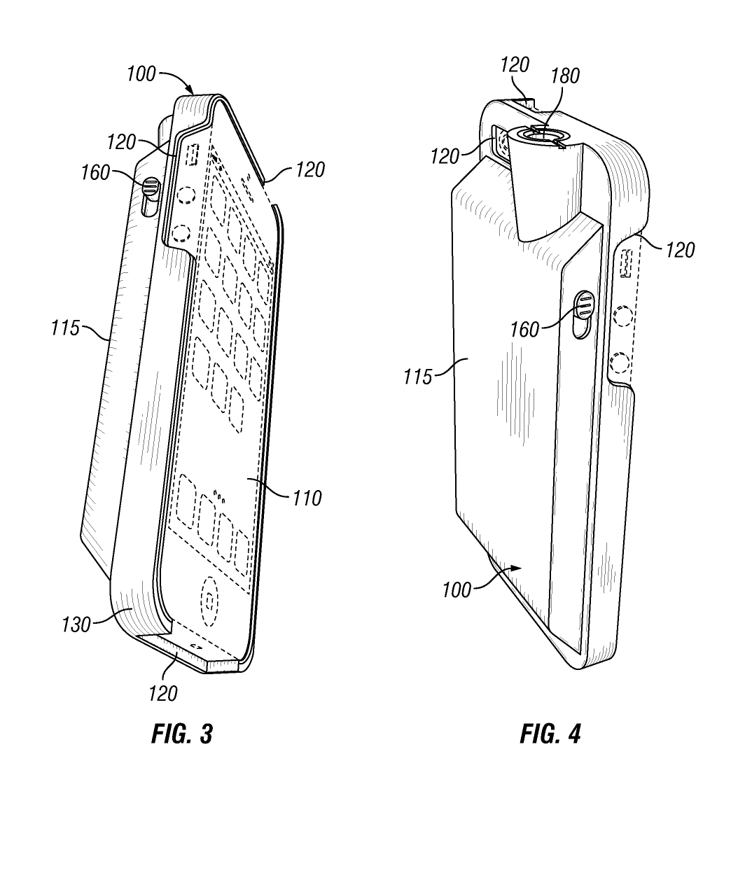

In some embodiments, power from the battery 140 may be selectively triggered by a button, knob, or other switch, 170 on the case 100. As shown in FIGS. 1-2, the switch 170 may be integral with voltage regulator 160, or as shown in FIGS. 3-6 may be a separate component located at a place different than the voltage regulator 160. Other locations for the switch 170 and voltage regulator 160 are also possible.

For some embodiments, a threaded power connector 180 is included near a top edge of the case 100. Threaded power connector 180 is capable of mating with an atomizer/heating element 190, or a tank 200, or some combination thereof, of an electronic vapor device 210. Embodiments of threaded power connector 180 may also be plated (e.g., silver, nickel, stainless steel, or the like).

The particular threading and configuration of threaded power connector 180 may vary with the mating capabilities of the intended electronic vapor device 210. For example, some embodiments of power connector 180 may be threaded with a 7 mm×0.5 threading to match so-called “510” threading of some electronic vapor devices 210. Other threadings, such as “eGo” threading, as well as other mechanisms for connecting (bayonet, snap-fit, or the like) are also possible. In addition, various adapters, connectors, collars, or the like, may be provided to allow threaded power connector 180 to mate with any number of electronic vapor devices 210.

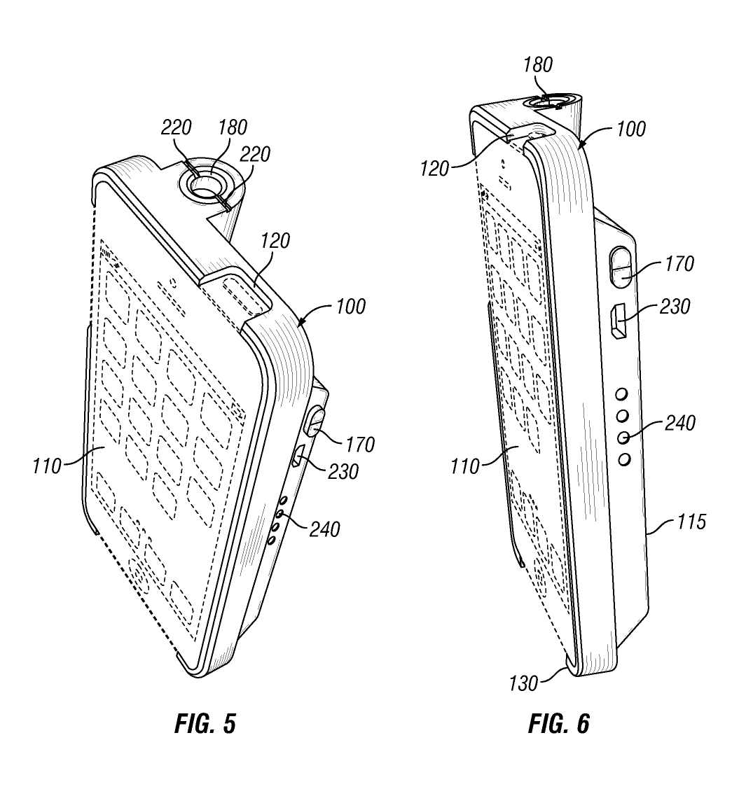

As best shown in FIG. 5, embodiments of the cellular device case 100 may also include vents 220 at, in, or near the threaded power connector 180 to facilitate air flow to the electronic vapor device 210. Other configurations of the vents 220 may also be used.

In some embodiments, and as shown in FIGS. 5-6, the device case 100 may also include a charging port 230 to allow recharging of the battery 140. For example, charging port 230 may comprise a micro-USB charging port. Other charging ports are also possible.

In some embodiments, the device case 100 may include suitable circuitry (not shown) in electrical communication with battery 140 and/or charging port 230 to enable various power management functionalities. For example, fast-charging circuits (e.g., to reduce charging time), auto-cutoff circuits (e.g., to conserve battery during times of no use), and power level indicator circuits (e.g., to indicate a battery 140 charge level) may be included in device case 100 to facilitate battery 140 power management. Coincident with some, or all, of these power management features, some embodiments of device case 100 may include indicators 240 to indicate operation of the various power management features. For example, device case 100 may include one or more LED indicators 240 that light up, or change color or intensity, to indicate a charge level of the battery. Other uses of the indicators 240 are also possible.

As should be apparent from the present disclosure, the device case 100 enables the use of electronic vapor device 210 independently of the use of cellular device 110. Likewise, electronic vapor device 210 and cellular device 110 may be used simultaneously.

Although various embodiments have been shown and described, the present disclosure is not so limited and will be understood to include all such modifications and variations are would be apparent to one skilled in the art.

What is claimed is:

1. A cellular device case comprising:
at least one edge to allow the mounting of a cellular device therein;
a recess to house a battery;
a voltage regulator to vary the output of a battery; and
a power connector to allow the connection of an electronic vapor device.

2. The cellular device case of claim 1 wherein the power connector is threaded.

3. The cellular device case of claim 2 wherein the power connector is threaded at 7 mm×0.5.

4. The cellular device case of claim 1 wherein the voltage regulator further comprises a variable voltage regulator.

5. The cellular device case of claim 4 wherein the variable voltage regulator varies an output voltage in increments of 0.75 volts.

6. The cellular device case of claim 4 wherein the variable voltage regulator varies an output voltage from 2.0 to 6.0 volts.

7. The cellular device case of claim 4 wherein the variable voltage regulator varies an output voltage from 2.75 to 5.0 volts.

8. The cellular device case of claim 1 further comprising a battery.

9. The cellular device case of claim 8 wherein the battery is a rechargeable battery.

10. The cellular device case of claim 9 wherein the rechargeable battery is a lithium-ion battery.

11. The cellular device case of claim 9 further comprising:
a battery charging port.

12. The cellular device case of claim 11 wherein the battery charging port further comprises a mini-USB port.

13. The cellular device case of claim 1 further comprising:
at least one vent in the power connector.

14. The cellular device case of claim 1 further comprising:
power management circuitry capable of electrical communication with a battery.

15. The cellular device case of claim 14 wherein the power management circuitry provides an indication of battery charge level.

16. The cellular device case of claim 15 further comprising:
at least one indicator that provides a visible indication of battery charge level.

17. The cellular device case of claim 16 wherein the at least one indicator is an LED.

18. The cellular device case of claim 14 wherein the power management circuitry provides a reduction in a battery charging time.

19. The cellular device case of claim 14 wherein the power management circuitry provides an automatic shut off of battery power.

20. The cellular device of claim 19 wherein the automatic shut off of battery power occurs after a predetermined time.
